(19) United States
(12) Patent Application Publication
(10) Pub. No.: US 2010/0117921 A1
(43) Pub. Date: May 13, 2010

(54) ORGANIC CONNECTING APPARATUS OF RECEIVING SET FOR A CAR

(76) Inventors: Kyeong-Soo Choi, Seoul (KR); Young-Sik Kim, Incheon (KR)

Correspondence Address: Law Office of ROBERT C. KLINGER, 2591 Dallas Parkway, Suite 300, FRISCO, TX, 75034, US

(21) Appl. No.: 12/452,540

(22) PCT Filed: Jul. 9, 2007
(86) PCT No.: PCT/KR2008/003961

§ 371 Date: Jan. 7, 2010

(30) Foreign Application Priority Data
Jul. 9, 2007 (KR) 10-2007-0068812

(51) Int. Cl. H01Q 21/28

(52) U.S. Cl. 343/876

(57) ABSTRACT

Disclosed herein is an integrated connection apparatus for the receivers of a car. The integrated connection apparatus for the receivers of a car, in which two or more receivers are installed in the car, a number of antennas equal to the number of the receivers are installed, and the receivers and the antennas are electrically connected to each other, includes an antenna filtering unit connected to the plurality of antennas and configured to filter radio wave signals, received through the respective antennas, for respective frequency bands, an integrated cable connected to the filtering unit, and configured to provide a path for collecting signals obtained through filtering and transmitting the signals to a receiver side, and a receiver filtering unit connected to the integrated cable, and configured to classify the signals, transmitted through the integrated cable, into signals suitable for the respective receivers and transmit them.

### TECHNICAL FIELD

The present invention relates to an integrated connection apparatus for the receivers of a car.

In particular, the present invention relates to an integrated connection apparatus for the receivers of a car that enables a plurality of receivers and relevant antennas to be connected through a single cable so as to enable the video/audio functions of the car, so that the connection of wiring can be performed more conveniently and quickly during the installation of the receivers and the antennas and the interior of the car can be kept neat.

### BACKGROUND ART

Recently, devices having various functions, such as a radio/audio listening and viewing function, a road guidance function using a Global Positioning System (GPS), a Division Multiple Access (CDMA) mobile communication function, and a Digital Multimedia Broadcasting (DMB) television viewing function, are separately installed in a car for use that is performed while the car is either moving or at rest.

FIG. 1 is a circuit diagram showing the construction of the prior art connection of the receivers of a car.

Referring to this drawing, the above-described devices having their respective functions receive radio waves from external broadcasting stations, satellites, base stations and the like, and perform their intended functions. Accordingly, in order to receive radio waves transmitted from the outside, the devices are equipped with their respective receivers 1. In order to improve the efficiency of the reception of radio waves, the receivers 1 are provided with antennas 2 which are installed inside and/or outside a car.

The antennas 2 are installed inside and/or outside the car at locations at which the antennas 2 can receive radio waves most effectively, and are respectively connected to the receivers 1 of the devices via their respective cables 3. In particular, since the antennas 2 for respective devices have different configurations for receiving radio waves, the respective receivers 1 require corresponding antennas 2.

In the above construction, in the installation of the receivers 1 and the antennas 2 in a car, the receivers 1 are generally disposed or fixedly mounted under the driver's seat or front passenger's seat of the car, and the antennas 2 are mounted on the upper frame of the driver's seat or front passenger's seat or on the outside of a car body. In particular, when a plurality of receivers 1 is provided (a plurality of receivers is installed for the performance of various functions), the receivers 1 are generally collected and fixedly mounted in the dashboard of the driver's seat side or front passenger's seat side of a car, or under a seat.

In the state in which the receivers 1 and the antennas 2 are installed in the car as described above, the receivers 1 and antennas are electrically connected through respective cables in a 1:1 correspondence. That is, each receiver 1 and each antenna 2 are connected to each other through a dedicated cable 3. When a plurality of receivers 1 and a plurality of corresponding antennas 2 are provided, a plurality of cables 3 is required to connect the receivers 1 to the antennas 2.

### DISCLOSURE

### Technical Problem

According to the construction of the prior art connection between receivers and antennas, when a plurality of receivers is installed in a car, receivers are connected to the respective antennas through dedicated cables, with the result that a plurality of cables must be deployed and arranged. Accordingly, the above-described construction has problems in that a process of connecting a plurality of receivers to their antennas through cables inside a car is very inconvenient and the appearance of the interior of a car is deteriorated by the plurality of cables after making the connection using the cables.

In particular, the above-described cable is configured to be extended by disposing connectors at one or more locations depending on the distance between the receivers and the antennas. As a result, when one or more connectors are disposed in each of the cables, there are problems in that the wiring in the car is more complicated and time and economic losses are incurred due to construction of the plurality of connectors.

The present invention was devised to solve the above problems. Accordingly, an object of the present invention is to provide an integrated connection apparatus that integrates radio wave signals (hereinafter referred to as “signals”) received through a plurality of antennas, transmits an integrated signal to a receiver side, divides the signal, and provides resulting signals to respective target receivers, thereby enabling signals to be transmitted to a plurality of receivers through a single cable.

### Technical Solution

In order to accomplish the above objects, the present invention has the following constructions.

The present invention provides a construction in which two or more receivers are installed in the car, a number of antennas equal to the number of the receivers are installed, and the receivers and the antennas are electrically connected to each other, including an antenna filtering unit connected to the plurality of antennas and configured to filter radio wave signals, received through the respective antennas, for respective frequency bands; an integrated cable connected to the filtering unit, and configured to provide a path for collecting signals obtained through filtering and transmitting the signals to a receiver side; and a receiver filtering unit connected to the integrated cable, and configured to classify the signals, transmitted through the integrated cable, into signals suitable for the respective receivers and transmit them. Furthermore, in the present invention, a power unit is provided in a signal dividing circuit so as to supply power used to operate the receiver, and the power unit includes a power cable installed in the integrated cable so as to supply power from the car.

Furthermore, in the present invention, a power unit is provided in a signal dividing circuit so as to supply power used to operate the receiver, and the power unit includes a power cable installed in the integrated cable so as to supply power from the car.

Preferably, a coaxial cable capable of transmitting various information through a single cable is used as the integrated cable. Furthermore, each filtering unit is installed and cased in a single box.

With regard to additional construction, the antenna filtering unit is provided with an integrating circuit for receiving filtered signals and integrating the signals into an integrated signal, whereas the receiver filtering unit is provided with a signal dividing circuit for dividing the transmitted integrated signal into a plurality of signals before the integration.

### Advantageous Effects

According to the present invention having the above-described construction, the connection of a plurality of receivers for performing various functions to respective antennas is implemented using a single cable, and thus a process of connecting the receivers to the respective antennas can be easily performed. Furthermore, the present invention has an advantage in that the neat appearance of the interior of a car can be achieved by the single cable.

In particular, the present invention has an advantage in that, through the use of the single cable, low manufacturing costs and rapid manufacturing work can be realized during the manufacturing of connectors.

### DESCRIPTION OF DRAWINGS

FIG. 1 is a circuit diagram showing the construction of the prior art connection of the receivers of a car;

FIG. 2 is a circuit diagram of a connection apparatus for the receivers of a car according to the present invention;

FIG. 3 is a sectional view of the integrated cable of the connection apparatus according to the present invention; and

FIG. 4 is a circuit diagram of another embodiment of the present invention.

### DESCRIPTION OF REFERENCE CHARACTERS OF PRINCIPAL ELEMENTS

| | |
|---|---|
| 10: receiver | 20: antenna |
| 30: antenna filtering unit | 40: integrated cable |
| 50: receiver filtering unit | 60: power unit |
| 70: integrating circuit | 80: dividing circuit |

### Best Mode

Embodiments of the present invention to which the above-described construction is applied will be described in detail below with reference to the accompanying drawings.

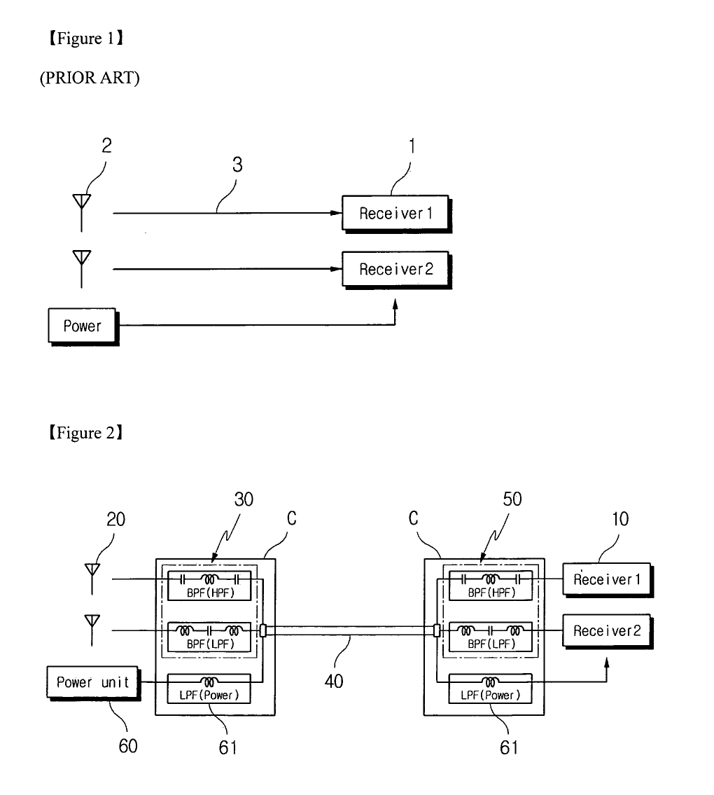

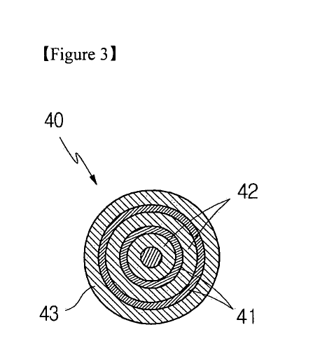

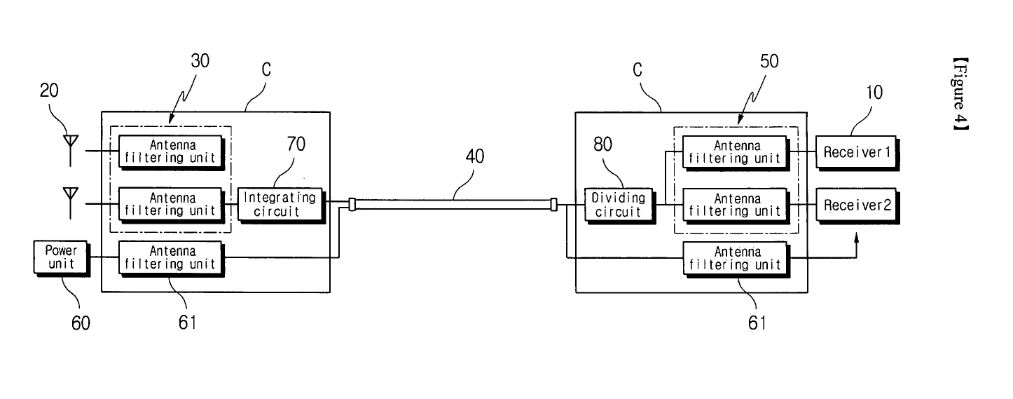

FIG. 2 is a circuit diagram of a connection apparatus for the receivers of a car according to the present invention, and FIG. 3 is a circuit diagram of the filtering unit of the connection apparatus according to the present invention.

Referring to the drawings, the connection apparatus according to the present invention is configured such that two or more receivers 10 are installed in a car, a number of antennas 20 equal to the number of receivers 10 are installed, and the receivers 10 are electrically connected to the antennas 20. For this purpose, the connection apparatus includes an antenna filtering unit 30, an integrated cable 40, a receiver filtering unit 50, and a power unit 60. Here, although two receivers 10 are illustrated in the drawing, there may be provided two or more types of receivers chosen from among a plurality of types of terminals, which are exemplified by a radio receiver, a GPS terminal, a CDMA terminal, and a DMB terminal.

The antenna filtering unit 30 is electrically connected to the antennas 20. The antenna filtering unit 30 is configured to classify radio wave signals, received through the antennas 20, according to frequency bands and then pass them therethrough in order to enable use of the radio wave signals for respective functions of the various receivers 10.

In order to perform filtering for respective frequency bands, it is apparent that the filtering unit 30 is divided into a High Pass Filter (HPF), a Low Pass Filter (LPF), and a Band Pass Filter (BPF). It is well known that the filtering unit 30 is constructed by connecting capacitors and coils in circuit form.

The integrated cable 40 is connected at both ends thereof to the antenna filtering unit 30 and the receiver filtering unit 50, and transmits various radio wave signals passed through the antenna filtering unit 30. Accordingly, a coaxial cable capable of transmitting various signals via a single cable is adopted as the integrated cable 40.

The integrated cable 40 is constructed by disposing respective conductive wires 41 for transmitting signals around the same axis and placing insulators 42 between the respective conductive wires 41 and a covering 43 in the outermost portion of the integrated cable 40, as shown in FIG. 3. Here, the conductive wires 41 are provided for two antennas 20, two receivers 10 and the power unit 60 because two types of antennas 20 and two types of receivers 10 are illustrated in the drawing.

In this case, the power unit 60 is a construction for supplying the power of the generator or battery of the car to the respective receivers 10. The power unit 60 includes a filtering unit 61 (or a power supply) for supplying power having appropriate voltage and current.

It is apparent that the above-described integrated cable 40 eliminates an electrical inference factor between radio wave signals because power and radio wave signals are separated from each other by the insulators 42 disposed between the respective conductive wires 41. In this regard, since radio wave signals obtained through the filtering of the antenna filtering unit 30 have different frequency bands, the electrical interference within the integrated cable 40 can be more reliably prevented.

The receiver filtering unit 50 is configured to filter the radio wave signals and power transmitted via the integrated cable 40 so that the transmitted radio wave signals and power can be provided to relevant receivers 10. That is, the receiver filtering unit 50 is a construction for classifying the radio wave signals and power for the use of the receivers 10 and the supply of power and inputting them.

The receiver filtering unit 50 also classifies the radio wave signals and power for an HPF, an LPF and a BPF, like the antenna filtering unit 30. The receiver filtering unit 50 is formed of capacitors and coils in circuit form.

In the above-described construction, the receiver filtering unit 50 and the antenna filtering unit 30 are each contained and cased in a single box C (a casing, such as a distribution box in which a circuit is included). Here, the two boxes C each include the power filtering unit 61 (see FIGS. 3 and 4). Using this construction, the circuits can be hidden in the interior of the car, and thus a neat appearance can be provided to the interior of the car.

### Another embodiment

FIG. 4 is a circuit diagram of another embodiment according to the present invention.

As is shown in this drawing, in a connection apparatus according to this other embodiment, an integrating circuit 70 for integrating filtered signals after radio wave signals received through antennas 20 have been filtered, is provided in an antenna filtering unit 30. Meanwhile, a dividing circuit 80 for receiving integrated signals via an integrated cable 40 and dividing the signals into original radio wave signals is provided in a receiver filtering unit 50.

In this case, circuits for passing only signals having specific frequency bands therethrough using capacitors and coils are used as the filtering units 30 and 50, as in the previous embodiment. The integrated cable 40 using the coaxial cable is formed of an integrated conductive wire 41 for transmitting integrated radio wave signals, and includes conductive wires 41 for transmitting radio wave signals and a conductive wire 41 for transmitting power.

It is preferred that the integrating circuit 70 be implemented using a typical Frequency Division Multiplexing (FDM) circuit. Furthermore, it is preferred that the dividing circuit 80 is implemented using a typical convolution circuit for dissolving signals.

It is apparent that a separate coaxial conductive wire 41 is formed in the integrated cable 40 because, in the connection apparatus to which the integrating circuit 70 and the dividing circuit 80 are applied, the power unit 60 transmits power signals different from radio wave signals.

The above-described construction of another embodiment enables the integrated cable 40 to be manufactured at low costs, and enables a connector for the integrated cable 40, which is generally extended one or more times, to be fabricated in a simple structure.

1. An integrated connection apparatus for receivers of a car, in which two or more receivers (10) are installed in the car, a number of antennas (20) equal to the number of the receivers (10) are installed, and the receivers (10) and the antennas (20) are electrically connected to each other, comprising:
a first box configured such that an antenna filtering unit (30) connected to the plurality of antennas (20) and configured to filter radio wave signals, received through the respective antennas (20), for respective frequency bands, and a first power filtering unit (61) configured to filter and supply voltage and current applied from the power unit (60) are contained and cased in the first box;
a coaxial integrated cable (40) connected to the first box, configured to provide a path for collecting signals obtained through filtering of the antenna filtering unit (30) and power obtained through filtering of the power filtering unit (61) and transmitting the signals and the power to a receiver side, and configured to simultaneously transmit various information through a single cable; and
a second box connected to the integrated cable (40), and configured such that a receiver filtering unit (50) configured to classify the signals, transmitted through the integrated cable (40), for the respective receivers (10) and transmit them, and a second power filtering unit (61) configured to filter the power, transmitted through the integrated cable (40), into voltage and current suitable for the respective receivers (10) are contained and cased in the second box.

2. The integrated connection apparatus as set forth in claim 1, wherein the antenna filtering unit (30) is provided with an integrating circuit (70) for receiving the plurality of signals that are obtained through the filtering and integrating the respective signals into an integrated signal, and the receiver filtering unit (50) is provided with a signal dividing circuit (80) for dividing the transmitted integrated signal into the plurality of signals which was present before the integration.
